(19) United States
(12) Patent Application Publication
(10) Pub. No.: US 2004/0007107 A1
(43) Pub. Date: Jan. 15, 2004

(54) Paper cutter with lockable pivot pin

(76) Inventors: Harold Leslie Bost, Statesville, NC (US); Michael Lee Parrish, Huntersville, NC (US)

Correspondence Address: Gregory S. Bernabeo, Esq., Synnestvedt & Lechner LLP, 2600 Aramark Tower, 1101 Market Street, Philadelphia, PA, 19107-2950, US

(21) Appl. No.: 10/403,228

(22) Filed: Mar. 28, 2003

Related U.S. Application Data
(60) Provisional application No. 60/395,007, filed on Jul. 11, 2002.

(51) Int. Cl. B26D 1/00

(52) U.S. Cl. 83/13; 83/607; 83/698.11

(57) ABSTRACT

A paper cutter including a cutting arm pivotally mounted to a base by a pivot pin having at least two different thread sizes on adjacent portions of its distal end. A first section bears threads of a first size that are complementary to threads of a nut. A second section adjacent the first portion bears threads of a second size different from the first size. The nut is threaded onto the first section of the pivot pin having complementary threads, and then forcibly driven onto the second section of the pivot pin having mismatched threads. This positively locks the nut onto the pivot pin by deforming at least a portion of the mismatched threads. The cutting arm is thereby locked using a single nut and a second lock nut and related assembly steps are thereby eliminated. A method for assembling such a paper cutter is also provided.

### CROSS-REFERENCE TO RELATED APPLICATION

This application claims the benefit of U.S. Provisional Patent Application No. 60/395,007, filed Jul. 11, 2002, the entire disclosure of which is hereby incorporated by reference.

### FIELD OF THE INVENTION

The present invention relates generally to a cutter for sheet material having a blade bearing pivotable cutting arm mounted to a cutting board, and particularly to a cutting arm pivot pin that is lockable without the need for a lock nut.

### DISCUSSION OF RELATED ART

Cutters or trimmers for sheet material, typically referred to as paper cutters, are in widespread use in educational, institutional, commercial, corporate and other environments for cutting paper, cardboard or sheets of other materials. An exemplary paper cutter has a flat cutting board base that has a sharp cutting edge on a side of the base, and a cutting arm pivotally mounted to the base adjacent the sharp cutting edge. The cutting arm supports a sharp blade that cooperates with the cutting edge on the side of the base to cut any sheets therebetween when the cutting arm is pivoted to draw its blade along the cutting edge in a scissor-like action.

Exemplary paper cutters are shown in U.S. Pat. Nos. 2,256,606 to Blanc, 2,327,000 to Lund, 2,345,450 to Blanc, 2,460,842 to Murphy et al., and 2,591,472 to Segal. These paper cutters are exemplary of many well-known paper cutters in which the cutting arm is attached to the base by a threaded pivot pin. This pivot pin is attached at one end to the cutting arm. The pivot pin's other end extends through a mounting boss of the base. The pivot pin is secured to the base by threading a first nut onto the end of the pivot pin, which has threads complementary to those of the first nut.

The cutting arm is pivotable relative to the base about the pivot pin to perform cutting operations. Pivoting of the cutting arm, however, tends to loosen the nut. To prevent this, as known in the art, a second nut can be threaded onto the pivot pin and tightened against the first nut, thereby acting as a lock nut to lock the pivot pin in place. This adds to the parts and manufacturing costs of the paper cutter.

Adding further to the costs of the paper cutter are the pivot pin and cutting arm, which are typically separate parts that are assembled during manufacture of the paper cutter. The pivot pin and nuts are usually manufactured of steel or other metal, and the cutting arm is usually metal or molded synthetic resin. Such arrangements require several parts, and several assembly steps to install such parts, and therefore add undesirably to manufacturing costs for the paper cutter.

The use of numerous separate parts, including a second (lock) nut, adds undesired parts, assembly steps and related costs to the paper cutter. What is needed is a pivot pin/nut arrangement that reduces or eliminates these undesirable parts, assembly steps and/or costs.

### SUMMARY OF THE INVENTION

The present invention provides a pivot pin that allows for locking of the cutting arm and/or pivot pin using a single nut and therefore eliminates the need for a second (lock) nut and the additional manufacturing step of driving the second nut.

A cutting arm in accordance with the present invention has a pivot pin extending transversely to a direction of elongation of the cutting arm. Optionally, the pivot pin is integrally formed with the cutting arm as a unit, e.g. by injection molding with a synthetic resin, to further reduce parts and/or assembly costs. A distal end of the pivot pin has a first section bearing threads of a first size, and a second section adjacent the second section bearing threads of a second size different from the first size. Accordingly, two different thread sizes are provided on adjacent sections of the pivot pin.

A cutting arm assembly for a paper cutter is also provided which includes such a cutting arm and a nut having internal threads complementary to the threads of the pivot pin's first portion. The nut is forcibly threaded onto the threads of the pivot pin's second portion of the pivot pin, and so is forcibly threaded onto mismatched threads. This causes the nut to deform at least a portion of the pivot pin's threads and thereby positively lock the nut onto the pivot pin.

A paper cutter including such a cutting arm assembly and a method for assembling such a paper cutter are also provided.

### DESCRIPTION OF THE DRAWINGS

FIG. 1 is a perspective view of a cutting arm in accordance with an exemplary embodiment of the present invention;

FIG. 2 is a top view of the cutting arm of FIG. 1;

FIG. 3 is an enlarged plan view of the pivot pin of the cutting arm of FIG. 1;

FIG. 4 is a perspective view of a paper cutter in accordance with an exemplary embodiment of the present invention; and

FIG. 5 is a bottom view of the paper cutter of FIG. 4, showing mounting of the cutting arm of FIG. 1.

### DETAILED DESCRIPTION

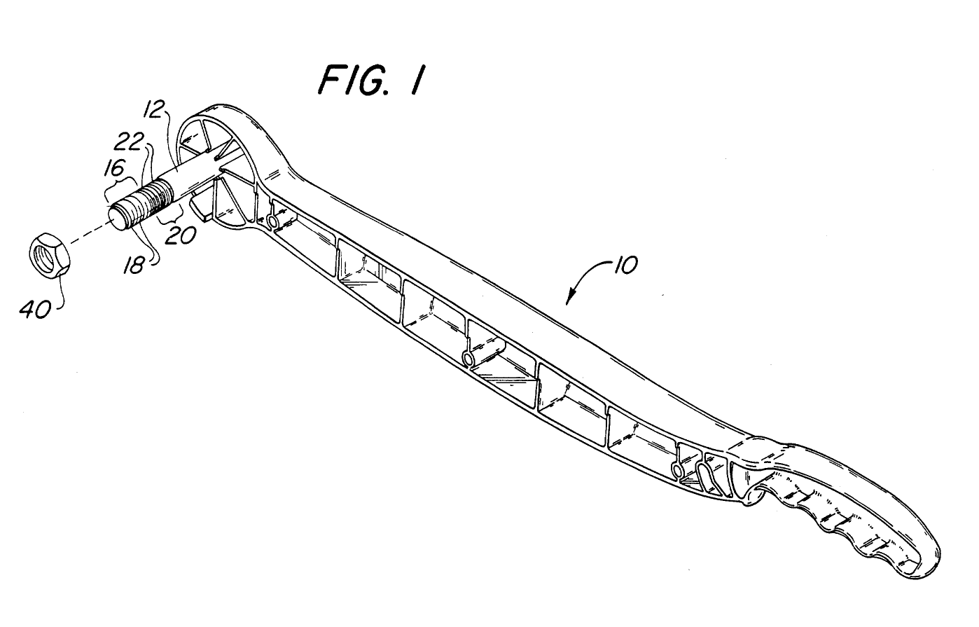

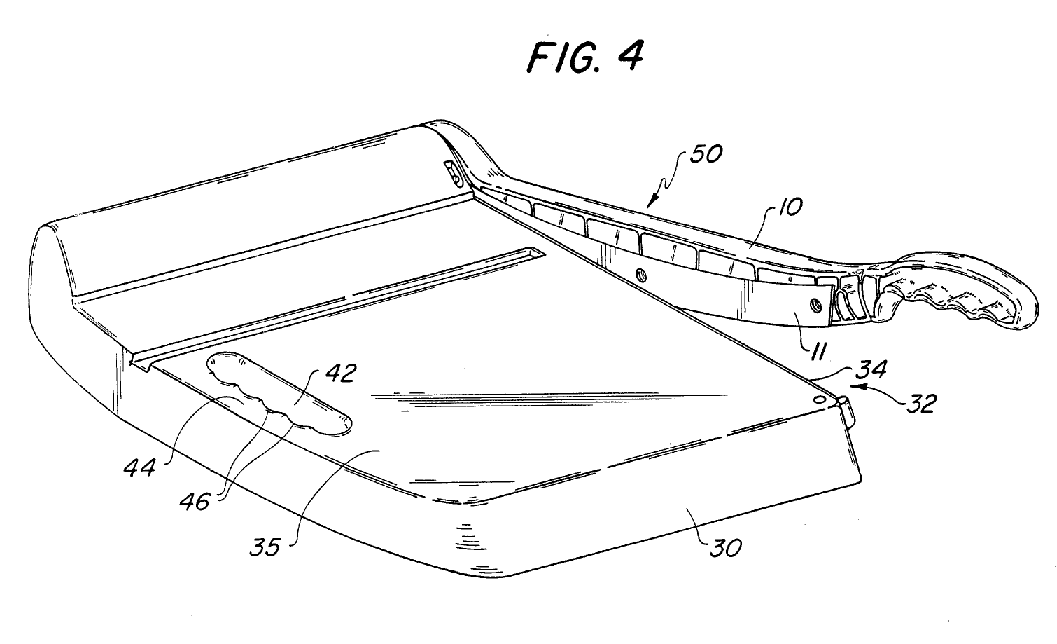

FIGS. 1-3 show a cutting arm 10 in accordance with an exemplary embodiment of the present invention that may be incorporated into a paper cutter 50 (see FIG. 4) of a type generally known in the art, which includes a base 30 having a surface 35 for supporting sheets to be cut, and a cutting arm 10 pivotally mounted at one end to the base 35 for pivotal motion in a substantially vertical plane. The cutting arm 10 has a blade 11 supported thereon, such as a steel blade, for cutting sheet material in cooperation with a cutting edge 34 of the base 30.

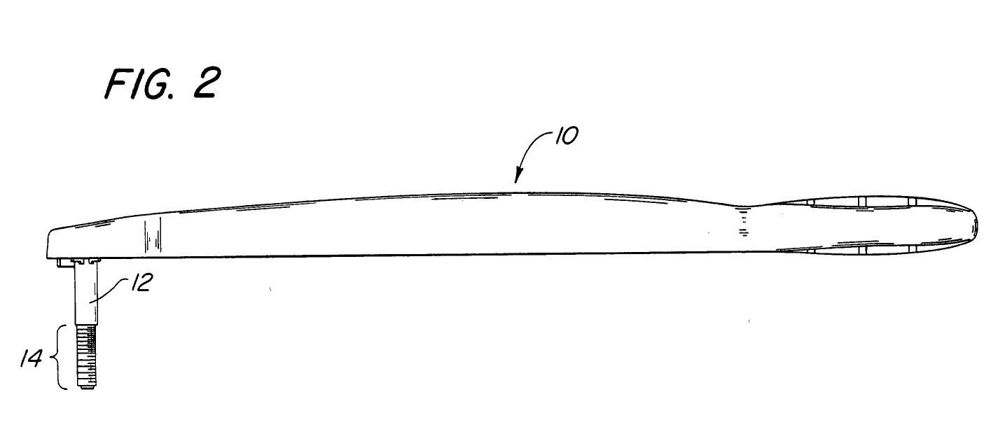

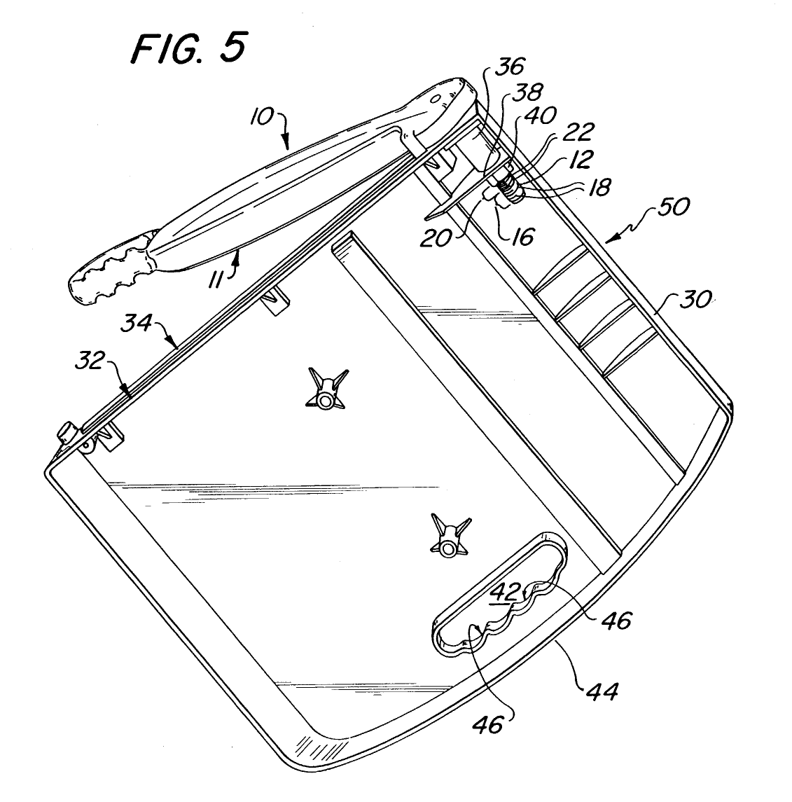

As shown in FIGS. 1-3, the cutting arm 10 is of a type generally known in the art as a component of a paper cutter in that it is elongated in a longitudinal direction and configured for supporting an elongated blade, such as a steel blade, for cutting sheet material, and has a pivot pin 12. As generally known in the art, the pivot pin 12 extends transversely to a direction of elongation of the cutting arm 10 for pivotally mounting the cutting arm 10 to a base of the paper cutter for pivotal motion in a substantially vertical plane, as best shown in FIGS. 1 and 2. An exemplary paper cutter including the cutting arm 10 is shown in FIGS. 4 and 5.

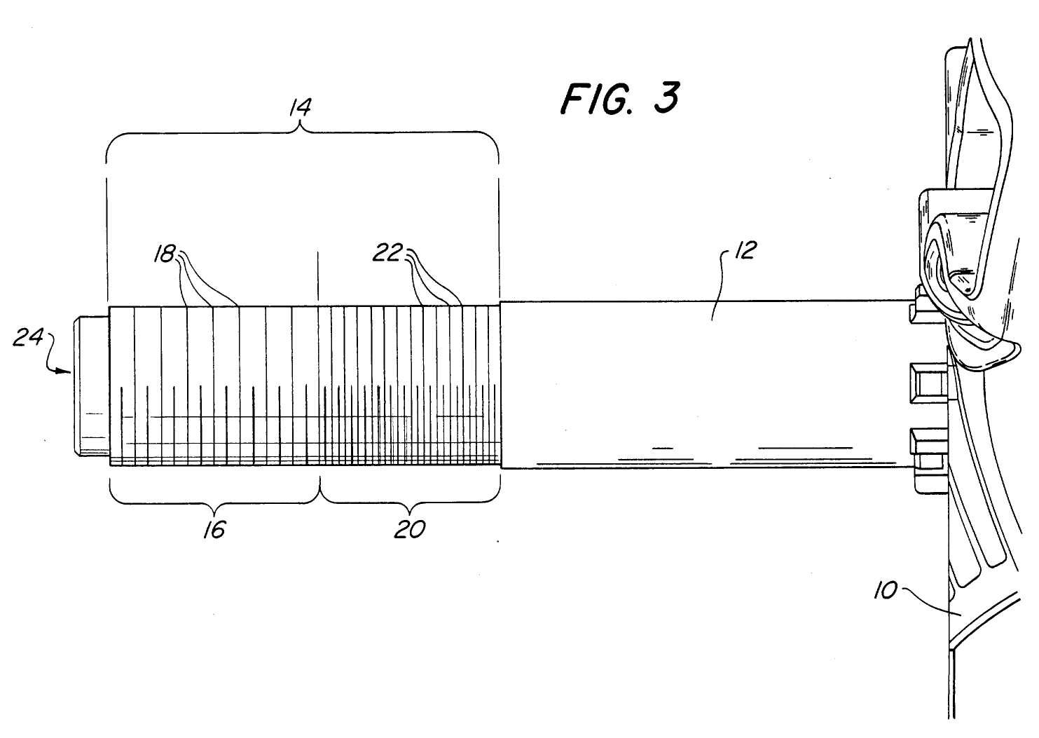

In accordance with the present invention, a distal end 14 of the pivot pin 12 bears threads of two different sizes for receiving a nut for mounting the cutting arm 10 to the base of a paper cutter, as best shown in FIG. 3. As shown in FIG. 3, the pivot pin 12 has a first section 16 bearing threads 18 of a first size. In addition, the pivot pin 12 has a second section 20, adjacent the first section 16, that bears threads 22 of a second size different from the first size.

In a preferred embodiment, as shown in FIG. 3, the first section 16 has relatively coarse external threads, such as standard threads of twenty (20) threads per inch, and the second section 20 has relatively fine external threads, such as standard threads of approximately twenty-four (24) threads per inch. While these thread sizes have been found suitable for a pivot pin having a diameter of approximately one-half inch, any suitable thread sizes and pivot pin sizes may be used.

Preferably, the first section 16 extends along the length of the pivot pin 12 from its tip 24 a distance sufficient to permit manual threading of a complementarily threaded nut onto the pivot pin, e.g. using one's fingers. For example, a distance of approximately one-quarter to three-quarters of an inch, and particularly five-eighths of an inch, has been found suitable for this purpose.

Optionally, the pivot pin 12 is fixedly joined to the cutting arm 10, e.g. by integrally forming the pivot pin 12 with the cutting arm 10 by injection molding a synthetic resin to form the pivot pin and the cutting arm as a unit, as best shown in FIG. 1. This provides a relatively lightweight and low cost cutting arm, and allows for formation of a pivot pin having different sized threads on adjacent portions.

FIG. 4 is a perspective view of a paper cutter 50 in accordance with an exemplary embodiment of the present invention. The paper cutter 50 of FIG. 4 is typical of those generally known in the art in that it includes a base 30 having a side 32 bearing a cutting edge 34 and a top surface 35 for supporting sheet material to be cut, and a cutting arm 10 pivotally mounted to the base 30 for pivotal motion in a substantially vertical plane. The cutting arm 10 supports a blade 11, such as a steel blade, for cutting sheet material. For example, the blade 11 may be fastened to the cutting arm 10 by screws or by injection molding the cutting arm to interlock with the blade 32. The base 30 and cutting arm 10 may be formed primarily of a synthetic resin, e.g. by injection molding, to provide a relatively lightweight and low cost paper cutter.

FIG. 5 is a bottom view of the paper cutter 50 of FIG. 4, showing mounting of the cutting arm 10 of FIG. 1. As shown in FIG. 5, the base 30 has a mounting boss 36 adjacent the cutting edge 34 that has an internal bore (not shown) for receiving the pivot pin 12. The first section 16 of the pivot pin's threads are positioned to extend beyond a stop surface 38 of the mounting boss 36 when the pivot pin is positioned to extend through the mounting boss 36, as shown in FIG. 5.

A nut 40 fastens the cutting arm 10 to the base 30. The nut 40 has internal threads (not shown) complementary to the threads 18 of the pivot pin's first section 16. For example, if the first section of the pivot pin 12 has standard external threads of 20 threads per inch, the nut has standard internal threads of 20 threads per inch. Accordingly, the nut 40 may be advanced onto the first section 16 of the pivot pin 12 with little effort, e.g. by manually threading the nut with one's fingers.

At least a portion of the threads 22 of the pivot pin's second section 20 is also positioned to extend beyond the stop surface 38 of the mounting boss 36 when the pivot pin 12 is positioned therein. Accordingly, the nut 40 must be advanced onto the second section 20 of the pivot pin's threads to properly secure the cutting arm 10 to the base 30 for pivotal motion in a substantially vertically plane.

However, because the second section 20 of the pivot pin 12 has external threads 22 that are not complementary to the internal threads of the nut, i.e. they are of two different sizes, the nut 40 cannot be advanced onto the second portion of the pivot pin 12 with little effort, e.g. using one's fingers. Instead, the nut 40 must be forcibly threaded onto the second portion 20 of the pivot pin 12, e.g. by driving the nut 40 with a pneumatic or other powered tool onto the mismatched threads. The nut 40 is advanced onto the second portion 20 and against the stop surface 38 to secure the cutting arm 10 to the mounting boss 36 and therefore to the base 30. When the nut is forcibly driven in this manner, the nut 40 deforms at least a portion of the threads 22 of the pivot pin 12, and possibly internal threads of the nut 40. This causes the nut 40 to be positively locked onto the pivot pin 12 such that simple pivotal motion of the cutting arm 10 cannot, or likely will not, cause the nut 40 to loosen. For example, it has been found that forming the nut of a relatively hard material, such as steel, and forming the nut of a relatively soft material, such as a suitable synthetic resin, allows for appropriate deformation of the threads and locking of the nut. Alternatively, the materials for the nut and pivot pin are interchanged. Accordingly, a pivot pin/nut arrangement is provided that allows for locking of the cutting arm 10 and/or pivot pin 12 using a single nut 40, and therefore eliminates the need for a second (lock) nut and related assembly steps, and provides for reduction of certain manufacturing costs.

A paper cutter having a cutting arm, a base for supporting material to be cut and a mounting boss for supporting a cutting arm having a blade, may be assembled in accordance with the present invention as follows. First, a pivot pin 12 of the cutting arm 10 is positioned to extend through the mounting boss 36 of the base 30. In some embodiments, this requires assembly of the pivot pin 12 to the cutting arm 10 to cause the pivot pin 12 to extend transversely to a direction of elongation of the cutting arm 10. In the preferred embodiment, the pivot pin and cutting arm are integrally formed as a unit to further reduce parts and assembly costs.

A nut 40 having internal threads complementary to external threads of the pivot pin's first portion 16 (e.g. 20 TPI) is then advanced onto the first section 16 of the pivot pin 12. For example, this may be performed by manually threading the nut 40 onto the pivot pin 12 using one's fingers. This “starts” the nut 40 on the pivot pin 12.

The nut 40 is then forcibly driven onto the external threads of the pivot pin's second portion 20 (e.g. 24 TPI) to deform at least a portion of its external threads 22 and thereby positively lock the nut 40 onto the pivot pin 12. For example, this may be performed by a powered driving tool, such as an electrically or pneumatically driven power tool. Because the nut is already started on the pivot pin, use of a powered driving tool is facilitated. Application of a second (lock) nut is not required, and yet the cutting arm 10 is locked to the base.

Optionally, the paper cutter 50 may include an integral handle 44 for carrying the paper cutter 50. The integral handle 44 is formed as an integral part of the base 30. More specifically, the base defines an opening 42 internal to a perimeter of the base 30, such that the opening 42 extends through the base 30 to allow an individual's fingers to pass therethrough, as shown in FIGS. 4 and 5. In a preferred embodiment, the base 30 is contoured such that the opening 42 defines a plurality of arcuate finger holds 46 for interfitting with the individual's fingers, as shown in FIGS. 4 and 5. For example, base 30 may be injection molded to define the opening 42, handle 44 and finger holds 46.

Optionally, the present invention may include a structural safety latch and/or an integral handle, as disclosed in U.S. Provisional Patent Application No. 60/395,007 filed Jul. 11, 2002, U.S. patent application Ser. No. ______ Attorney Docket No. P25,631 USA), now U.S. Pat. No. ______ filed concurrently herewith, the entire disclosures of both of which are hereby incorporated herein by reference. Additionally, the present invention may include a vertical blade arrangement to further facilitate assembly and reduce costs, as disclosed in U.S. patent application Ser. No. ______ (Attorney Docket No. P25,631 USA), filed concurrently herewith, now U.S. Pat. No. ______ , the entire disclosure of which is hereby incorporated herein by reference.

Having thus described particular embodiments of the invention, various alterations, modifications, and improvements will readily occur to those skilled in the art. Such alterations, modifications and improvements as are made obvious by this disclosure are intended to be part of this description though not expressly stated herein, and are intended to be within the spirit and scope of the invention. Accordingly, the foregoing description is by way of example only, and not limiting. The invention is limited only as defined in the following claims and equivalents thereto.

What is claimed is:

1. A cutting arm for a paper cutter, said cutting arm extending in a longitudinal direction, said cutting arm comprising:
a pivot pin extending substantially transversely to said longitudinal direction;
said pivot pin having a distal end having a first section and a second section adjacent said first section;
said first section having threads of a first size; and
said second section having threads of a second size different from said first size.

2. The cutting arm of claim 1, wherein said pivot pin is fixedly joined to said cutting arm.

3. The cutting arm of claim 2, wherein said pivot pin is integrally formed with said cutting arm.

4. The cutting arm of claim 3, wherein said pivot pin and said cutting arm are integrally formed by injection molding of a synthetic resin.

5. The cutting arm of claim 1, further comprising an elongated cutting blade mounted on said cutting arm.

6. The cutting arm of claim 1, wherein said first section comprises coarse threads, and said second section comprises fine threads.

7. The cutting arm of claim 1, wherein said threads of said first size comprises approximately twenty threads per inch, and said threads of said second size comprise approximately twenty-four threads per inch.

8. A cutting arm assembly for a paper cutter, comprising;
a cutting arm having a pivot pin extending substantially transversely to a direction of elongation of said cutting arm, a distal end of said pivot pin bearing external threads of a first size; and
a nut having internal threads of a second size different from said first size, said nut being forcibly threaded onto said external threads of said first size;
whereby said nut deforms at least a portion of said external threads of said first size to be positively locked onto said pivot pin.

9. The cutting arm assembly of claim 8, wherein said cutting arm further comprises external threads of said second size, said external threads of said second size being disposed on said pivot pin between a tip of said pivot pin and said threads of said first size.

10. The cutting arm of claim 8, wherein said pivot pin is fixedly joined to said cutting arm.

11. The cutting arm of claim 10, wherein said pivot pin is integrally formed with said cutting arm.

12. The cutting arm of claim 10, wherein said pivot pin and said cutting arm are integrally formed by injection molding of a synthetic resin.

13. The cutting arm of claim 8, further comprising an elongated cutting blade mounted on said cutting arm.

14. The cutting arm of claim 8, wherein said external threads of a first size comprise fine threads, and said external threads of said second size comprise coarse threads.

15. The cutting arm of claim 14, wherein said threads of said first size comprise approximately twenty-four threads per inch, and said threads of said second size comprise approximately twenty threads per inch.

16. A paper cutter comprising:
a base for supporting material to be cut, said base having a side bearing a cutting edge, and a mounting boss adjacent said cutting edge;
a cutting arm having a blade;
a pivot pin supported on said cutting arm to extend substantially transversely to a direction of elongation of said cutting arm, a distal end of said pivot pin having a first section bearing external threads of a first size, and a second section adjacent said first section, said second section bearing external threads of a second size different from said first size, said pivot pin extending through said mounting boss of said base to pivotally mount said cutting arm to said base for pivotal motion in a substantially vertical plane to cut sheet material positioned on said base to overhang said cutting edge;
a nut having internal threads of said first size, said nut being forcibly threaded onto said external threads of said second size to secure said cutting arm to said mounting boss of said base;
whereby said nut deforms at least a portion of said external threads of said second size to be locked onto said pivot pin.

17. The paper cutter of claim 16, wherein said pivot pin is fixedly joined to said cutting arm.

18. The paper cutter of claim 17, wherein said pivot pin is integrally formed with said cutting arm.

19. The paper cutter of claim 18, wherein said pivot pin and said cutting arm are integrally formed by injection molding of a synthetic resin.

20. The paper cutter of claim 16, wherein said base has an internal opening extending therethrough to form a hand graspable handle.

21. The paper cutter of claim 20, wherein said opening defines a plurality of arcuate finger holds.

22. The paper cutter of claim 16, wherein said first section comprises coarse threads, and said second section comprises fine threads.

23. The paper cutter of claim 16, wherein said threads of said first size comprises approximately twenty threads per inch, and said threads of said second size comprise approximately twenty-four threads per inch.

24. A method for assembly a paper cutter having a base for supporting material to be cut and a mounting boss for supporting a cutting arm having a blade, said method comprising the steps of:
positioning a pivot pin of the cutting arm to extend through the mounting boss of the base, said pivot pin extending transversely to a direction of elongation of said cutting arm, a distal end of said pivot pin having a first section bearing external threads of a first size, and a second section adjacent said first section, said second section bearing external threads of a second size different from said first size;
threading a nut having internal threads of said first size onto said first section of said pivot pin; and
forcibly driving said nut onto said second section of said pivot pin to deform at least a portion of said external threads of said second size to lock said nut onto said pivot pin.

25. The method of claim 24, wherein said driving step is performed by a powered driving tool.

26. The method of claim 24, wherein said threading step is performed by manually threading the nut onto the pivot pin.
